(19) United States
(12) Patent Application Publication
(10) Pub. No.: US 2012/0112877 A1
(43) Pub. Date: May 10, 2012

(54) Automated Device/System Setup Based On Presence Information

(75) Inventors: Douglas David Gravino, Roswell, GA (US); Gopinath Radhakrishnan, Alpharetta, GA (US); Michael L. Poffenberger, Atlanta, GA (US)

(73) Assignee: Cox Communications, Inc., Atlanta, GA (US)

(21) Appl. No.: 12/941,385

(22) Filed: Nov. 8, 2010

(51) Int. Cl. G05B 19/02

(52) U.S. Cl. 340/4.31

(57) ABSTRACT

Automated device/system setup based on user presence information is provided. When a user of one or more electronic devices or systems moves into the presence of the one or more devices or systems, detection or determination of the user's presence may be used to apply setup or settings changes to the one or more devices or systems. The user's presence relative to the one or more devices or systems may be detected according to a variety of means. A wireless device carried by the user may be detected by a wireless presence detector. Online/offline status of a user with respect to an Internet connection may be used to detect/determine presence of the user. Use of a wireline or wireless telephone, cable television set-top box or other device connected to a services provider may be used to determine presence information for the user.

### BACKGROUND

In a modern home, business, school, or other facility, a variety of electronic devices may be in use in association with one or more communications services providers. For example, a given home or business may have a set-top box/television combination for receiving video/audio content from a cable or satellite-based services provider. The home or business may have wired and/or wireless telephones and data (Internet). The home or business or other facility may have wired and/or wireless alarm systems and, the home, business or other facility may have a variety of other electronic devices.

Oftentimes, use of such devices and systems or limitations on the use of such devices and systems is based on the physical presence of a given person. For example, in a given household, one member of a family may only desire to watch a certain number of television channels, but the user must “surf” through all available channels even if he/she is the only person presently on the premises. For another example, a parent may require that minor children may not watch certain television shows or utilize Internet connections while the parent is away from home. For another example, a parent or supervisor may require that only a specified set of telephone numbers may be dialed while the parent or supervisor is away. And, a user may desire to positively enable certain devices or systems upon the presence of the user, for example, alarm systems, automatic call forwarding features, and the like.

Unfortunately, for most of such devices or systems, a given user must order the use or limitation on use while the user is away, or the user must manually set use or limitations on use when the user leaves the presence of the devices or systems and when the user returns to the presence of such devices or systems. Thus, there is a need for automated device/system setup based on user presence information.

It is with respect to these and other considerations that the present invention has been made.

### SUMMARY

The above and other problems are solved by automated device/system setup based on user presence information. According to embodiments, when a specific user of one or more electronic devices or systems moved into the physical presence of the one or more devices or systems, automatic detection or determination of the user's presence may be used to apply setup or settings changes to the one or more devices or systems.

The user's presence relative to the one or more devices or systems in a known physical location may be automatically detected according to a variety of means. A wireless network may be detected by a wireless device carried by the user and communicated to a presence server to provide location information. Online/offline status of a user with respect to an Internet connection may be used to detect/determine presence of the user. Use of a wireline or wireless telephone, cable television set-top box or other device connected to a services provider may be used to determine presence information for the user.

Physical presence information detected or determined for the user may be passed to and stored at a presence server. Physical presence information may be pushed from the presence server to the one or more devices or systems as it is determined, or presence information may be pulled from the physical presence server by the one or more devices or systems on a periodic basis. According to one embodiment, the presence information for the user may pass to the one or more devices or systems via a communications services provider through which the one or more devices or systems operates. Upon receipt of the presence information for the user, operational settings or setup data for the one or more devices may be changed. For example, if a user's presence is detected in his/her home, presence information for the user may be passed to a cable television services provider via the presence server, and settings for the user's set-top box associated with his/her television and provided by the cable services provider may be changed so that only those television channels of interest to the user are provided through the set-top box. Alternatively, physical presence information for a given user may be stored and may be pulled periodically by one or more devices or systems for changing operational settings or setup data accordingly. According to another embodiment, physical presence information may be detected by a first device or system and may be communicated to a second device or system (without passing information through a presence server) so that operational settings or setup data may be changed.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

FIG. 1 illustrates a system architecture with which embodiments of the present invention may be practiced.

FIG. 2 is a flow diagram illustrating a routine for automating device/system setup based on presence information.

FIG. 3 illustrates a system architecture of a cable television services system with which some embodiments of the present invention may be implemented.

### DETAILED DESCRIPTION

As briefly described above, embodiments of the present invention are directed to automated device/system setup based on specific user presence information. When a user of one or more electronic devices or systems moves into or out of the presence of the one or more devices or systems, detection or determination of the user's presence or lack of presence may be used to apply setup or settings changes to the one or more devices or systems. The user's presence relative to the one or more devices or systems may be detected according to a variety of means. As should be appreciated, a device may include any device capable of being uniquely identifiable and can either be detected or can detect and communicate its location. A wireless device carried by the user may be detected by a wireless presence detector, or alternatively, a wireless device may detect a change in physical presence (e.g., presence of a familiar Wi-Fi hotspot or known BLUETOOTH device, etc.), and may communicate presence information to a presence server. Online/offline status of a user with respect to an Internet connection may be used to detect/determine presence of the user. Use of a wireline or wireless telephone, cable television set-top box or other device connected to a services provider may be used to determine presence information for the user. Physical presence may also be determined via traditional wireless carrier location determining methodologies such as, but not limited to: triangulation, trilateration, multilateration, etc. Physical presence may be determined via a GPS or assisted GPS system, Other location-detection systems (e.g., RFID tags) may be incorporated into a frequently carried device (e.g., a wallet), and may be detected upon ingress or egress of a specific location.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

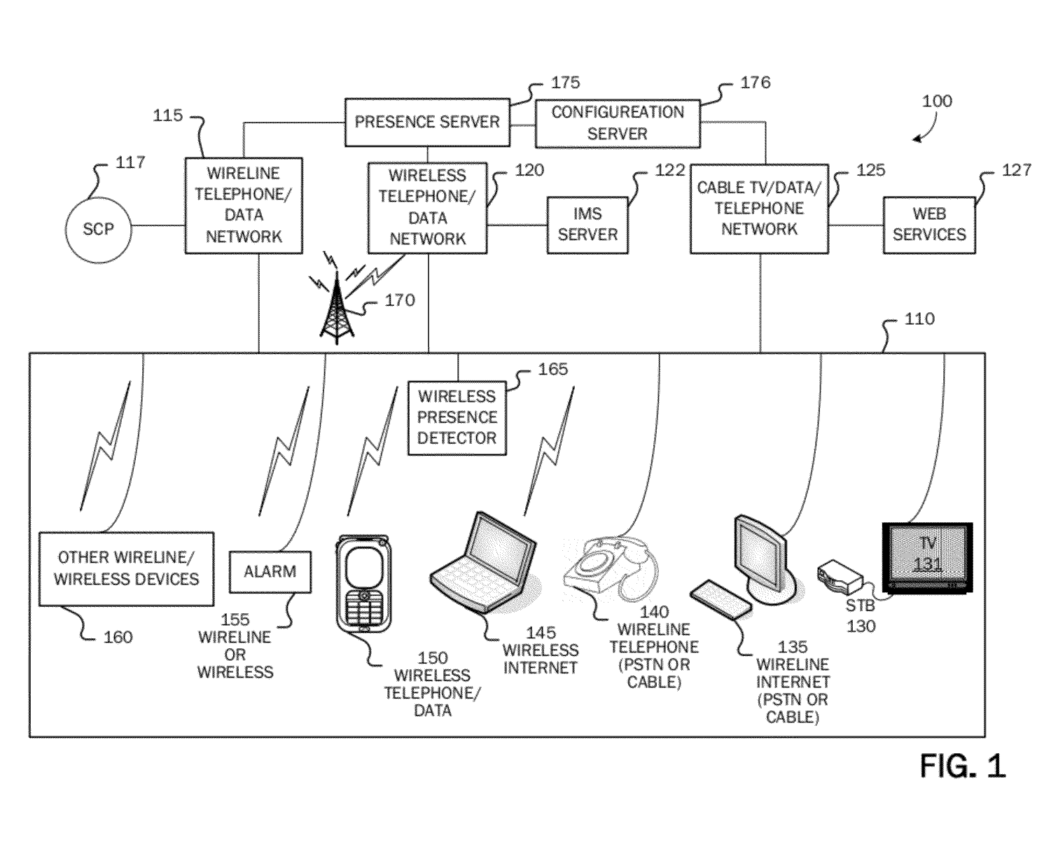

FIG. 1 illustrates a system architecture with which embodiments of the present invention may be practiced. Referring to FIG. 1, three example communications services providers are illustrated for providing a variety of communications services to a home, business, or other facility 110 (hereafter “facility”). Along the upper side of FIG. 1, a wireline telephone data network 115 is illustrated for providing traditional publicly switched wireline telephony and data to the facility 110. A service control point 117 is illustrated in association with the wireline telephone/data network 117 for providing intelligent communication services to telecommunications end points in the facility 110. For example, if telephone calls are made via the wireline telephone/data network 117 to a wireline telephone 140, or if wireline data is provided via the wireline network 115 to a wireline computer 135, the service control point 117 may be operative for providing specialized call features and data management, for example, call forwarding, caller identification, data bandwidth management, data rate, and the like.

A wireless telephone/data network 120 with an associated wireless transmission point 170 (e.g., cell tower) is illustrated for providing wireless telephony and data services to one or more end points in the facility 110. For example, a wireless telephone 150 may be used for sending and receiving voice and data communications via the wireless telephone/data network 120. A computer 145 is illustrated for sending and receiving wireless data and other wireless-enabled communications via the wireless telephone/data network 120. An IMS server 122 is illustrated in association with the wireless telephone/data network 120 for managing and processing data associated with subscribers and subscriber features operated via the wireless telephone/data network 120. According to one embodiment, an IMS (Internet Protocol Multimedia Subsystem) server is a system operative to allow for data services, including Internet services, and access to multimedia and voice applications via a wireless network 120.

Referring still to FIG. 1, a cable television/data/telephone network 125 is illustrated for providing cable television services through a cable television/set-top box combination 130. The cable television/data/telephone network 125 is also operative for providing cable-based wireline Internet services to a computer 135 and cable-based wireline telephony services to a wireline telephone 140. A web services platform 127 is illustrated in association with the cable television/data/telephone network 125 for allowing subscriber access to and management of one or more services, features, or data items maintained for and operated on behalf of the subscriber via the cable television/data/telephone network 125.

Operation of a wireline telephone/data network 115, a wireless telephone/data network 120 and a cable television/data/telephone network 125 are well known to those skilled in the art. According to embodiments, each of the networks 115, 120, 125 may operate as independent communications services providers, or each of the networks or a combination of one or more of the networks may be operated via a single communications services provider operative for providing integrated services across the three networks 115, 120, 125, or combinations thereof.

As will be described in detail below, the three illustrated communications networks 115, 120, 125 may be utilized for receiving presence information associated with a subscriber and for altering one or more settings of a given end point device based on a subscriber's presence in proximity to the end point device. For example, detection of the presence of a subscriber in proximity to the cable television/set-top box combination 130, described below, may be used to cause the cable television/data/telephone network 125 to change operating settings of the set-top box 130 to provide particular viewing content desired by the subscriber who is in the presence of the end point device (e.g. set-top box 130).

Referring still to FIG. 1, a home, business, or other facility 110 is illustrated in which a variety of electronic devices may be situated and/or utilized for providing a variety of services to users and which may be operated according to a variety of different settings particular to individual users. The cable television/set-top box combination 130 is illustrative of a device combination with which a user may receive and view a variety of content items including television content, movies, sports, entertainment, and the like via a cable television/data/telephone network 125. The wireline computer 135, the wireline telephone 140, the wireline alarm system 155, or other wireline devices 160 may be operative for services provision and communications via the cable television/data/telephone services network 125 or via a wireline telephone/data network 115. The wireless computer 145, the wireless telephone/data device 150, a wireless-enabled alarm system 155 or other wireless devices 160 may be operative for sending and receiving telephony traffic and data services via the wireless telephone/data network 120.

As should be appreciated, each of the devices and systems illustrated in the facility 110 may be operated according to a variety of different settings associated with individual users. For example, the cable television/set-top box combination 130 may be set up by a first user such that only a prescribed number of viewing channels are provided for the first user, and the cable television/set-top box combination 130 may be set up by a second user to provide a different set of prescribed viewing channels for the second user. As should be appreciated, the individualized user setup or settings may be processed locally at the set-top box 130, or the setup or settings for each individual user may be processed and stored at the cable television/data/telephone network back end 125.

The wireline computer 135 with which Internet and other data services may be available may likewise be set up for different operation for different users. For example, for the sake of parental and/or supervisory control, the wireline computer 135 may be set up via a wireline telephone/data network 115 or a cable television/data/telephone network 125 through which Internet or other data services are provided to the computer 135 such that varying levels of data access are provided depending on users having access to the computer 135. For example, a parent may desire that children are not allowed access to Internet or other data services via the computer 135 unless the parent is home in direct supervision over the child's data access.

The wireline telephone 140 may be set up according to user preference such that various features, for example, call forwarding, caller identification, and the like are set up differently for different users. For example, if a given user is not physically in the proximity of the wireline telephone 140, the user may desire that calls from his/her wireless telephone 150 should not be forwarded to the wireline telephone 140 until the user is in the physical proximity of the wireline telephone 140.

The computer 145 with Internet or other data services access via the wireless telephone/data network 120 similarly may be set up for operation, including data access, differently based on the physical proximity of different users to the device. For example, as described above with respect to the computer 135, a parent or supervisor may desire that Internet or other data access via the computer 145 may be limited depending on the physical proximity of various users to the computer 145.

The wireless telephone/data device 150 is illustrative of a portable or hand held computing/communications device that may be set up to operate according to various operating features and/or settings differently for different users. For example, a user may desire that when he/she is in the physical proximity of the wireline telephone 140, that all calls directed to the wireless telephone 150 be automatically forwarded to the wireline telephone 140 so that the user does not receive telephone calls at both the wireless telephone 150 and the wireline telephone 140.

The alarm system 155 is illustrative of an alarm system that may be operatively associated with the facility 110 for providing security services for the facility 110. As should be appreciated, the alarm system 155 may be set up according to a variety of operating features and settings. For example, the alarm system may be automatically activated at certain times of the day and automatically deactivated at other times of the day. The alarm system may be activated to silently alarm to authorities in the event of a security breach, or the alarm system may be set up to provide loud audible alarms on the premises 110 in the event of a security breach. According to embodiments, setup and/or other settings for the alarm system 155 may be different for different users who are in the presence of the alarm system 155. For example, if a parent or other supervisor is physically present in the facility 110, they may desire that the alarm system 155 is deactivated, but in contrast, they may desire that the alarm system is automatically activated if they leave the physical proximity of the facility 110.

The other wireline/wireless devices 160 are illustrative of any other device or system that may be operated in or in association with the facility 110 for which setup and/or other settings may be modified depending on the presence of different users in proximity to the devices 160.

According to embodiments, when the physical presence of a specific user is detected in the physical proximity of one of the electronic devices illustrated in FIG. 1, the user's presence in the physical proximity of the devices may be utilized for modifying the operational setup or settings of one or more of the electronic devices. As used herein, the term “specific or particular user” may refer to an actual specific user or may refer to a user associated with an electronic device or system. For example, if an actual specific user owns and operates a wireless telephone that is used to provide physical presence information of the user for changing settings of a given device or system when the user is in the physical presence of the device or system, then the presence of the example wireless telephone may be used for changing the example settings for that actual specific user. However, if another user (for example, the user's friend or relative) carries the example wireless telephone into the physical presence of the device or system in question, the presence of the wireless telephone may be interpreted as physical presence of the user who owns the wireless telephone as opposed to the person presently carrying the telephone. In such a case, the settings of the given device or system may be changed based on the physical presence of the wireless telephone instead of the physical presence of the user who owns the telephone.

As should be understood, physical proximity to the facility 100 (described herein) may vary according to the different requirements of the various electronic devices. For example, for changing settings to wireless data access for a wireless computing device 145, physical proximity within the range of a wireless transmitter/receiver at the facility may suffice. On the other hand, for changing settings to an alarm system 155, physical proximity within the facility may be a requirement.

Presence information for a given user may be detected according to a variety of different means. According to one embodiment, if a given user is carrying a wireless communications device, for example, the wireless telephone 150, the presence of the wireless communications device 150 may be detected by a variety of detection means for determining that the device is now in the physical proximity of the facility 110.

Referring still to FIG. 1, a wireless presence detector 165 is illustrative of one or more means for detecting presence of a wireless communications device 150. For example, the wireless presence detector 165 may be a wireless fidelity (WIFI) transmitter/receiver situated in the facility 110. When the wireless communications device 150 is brought within operational proximity of the WIFI transmitter/receiver, the wireless communications device 150 may be programmed to automatically detect all WIFI access points within range. Upon detection of a WIFI transmitter/receiver device, location information may be provided and utilized for indicating that the wireless communications device and an associated user are now in the physical proximity of the various devices illustrated in the facility 110. For example, a mobile phone 150 may be carried by a user. The mobile phone 150 may detect an SSID or base station MAC address of the user's home WIFI router via wireless transmission, and may then determine its physical location. Similarly, other wireless transmitter/receiver devices or sensors may be utilized for providing presence information for determining locations of wireless devices with respect to a wireless presence detector 165 and the facility 110 (e.g., low-powered WIFI base stations or BLUETOOTH devices that may be utilized for broadcasting location information and not routing data traffic).

According to other methods, the wireless telephone/data network 120 may determine the presence of a given wireless communications device 150, 145 based on the transmission/reception proximity of the devices to a wireless transmission point 170, for example, a wireless transmission antenna. In addition, satellite based geo-location receivers may be utilized for determining the physical location of the wireless devices 150, 145 and for determining that these devices have been brought into the physical proximity of the facility 110 and of the devices associated therewith. Such satellite based geo-location receivers may be associated with global positioning satellite systems (GPS) of various types, as well as, other types of geo-location systems, such as assisted-GPS (A-GPS) with which a mobile telephone network may be used to provide a starting or “seed” location value of a mobile device to a GPS system to enhance the efficiency of GPS location convergence. Other detection means may include embedded radio frequency identification (RFID) tags or other location-detection systems (for example, common retail anti-theft tags applied to goods) that may be embedded in always-carried devices or articles of clothing or accessories and that may be used to provide physical presence information for a user (for example, when such detection means pass a scanner or are detected upon ingress or egress of a specific area). As should be appreciated, each of the wireless presence detector means or combinations thereof described above may be utilized for determining presence of a user in the physical proximity of the facility 110.

In addition, presence of a given user in the physical proximity of the facility 110 may be determined via other means. For example, if a user utilizes the set-top box 130 by selecting a prescribed viewing profile associated with a particular user, the selection of the particular user profile may be utilized for determining that the particular user is now in the physical proximity of the set-top box 130 and thus the facility 110. For example, in order to utilize a given viewing profile, for example, a prescribed set of viewing channels, a given user may be required to enter a password or other credentials via the set-top box 130. Entry of a password or other credentials by a given user may be utilized for determining that the user is now in the physical proximity of the set-top box 130 and thus the facility 110.

Likewise, particular utilization of a wireline device such as the wireline telephone 140 or wireline data services via the computer 135 may be utilized for determining that a particular user is in the physical presence of the devices 140, 135 and thus in the physical presence of the facility 110. For example, if a particular user is required to enter a password or other credentials for data services, or specialized call processing via one of the devices 140, 135, entry of such password or credentials information may be utilized for determining that the particular user is in the physical presence of the devices 140, 135 and thus in the physical presence of the facility 110. Simple online/offline status of a given user likewise may be used to detect and/or determine the user's physical presence in the proximity of the facility 100.

Use or interaction with other devices in the facility 110, for example, the alarm system 155 or other wireline/wireless devices 160 may similarly be utilized for determining the physical proximity of a given user to those devices and to the facility 110. For example, if a particular user enters a password or other credentials into an alarm system 155, receipt of the password or other credentials may be utilized for determining that the particular user is now in the physical presence of the device/system and in the physical presence of the facility 110.

According to embodiments, physical presence information received for a particular user via one of the means described above may be passed to a presence server 175, illustrated in FIG. 1, in operative communication with each of the networks 115, 120, 125. According to embodiments, the presence server 175 is a general purpose computing system operative to receive and store presence information for a particular user for utilization of the presence information for modifying feature setup or other settings associated with one or more of the devices illustrated in the facility 110. According to one embodiment, the presence server 175 may operate as a standalone presence server from which presence information may be pushed out to interested services/systems or from which presence information may be pulled by interested services/systems as described below. Alternatively, the presence server 175 may be associated with one or more of the networks 115, 120, 125 for receiving presence information through the respective networks 115, 120, 125 and for providing presence information to the networks 115, 120, 125. For example, presence information obtained via detection of a WIFI network via a wireless device 150, 145 via a wireless presence detector 165 may be transmitted directly to the presence server 175 for subsequent use.

Alternatively, presence information determined from use of any of the devices illustrated in the facility 110 may be passed to the presence server via the individual networks 115, 120, 125 through which the devices are operated. For example, if presence information for a particular user is determined based on the user's access to the cable television/set-top box 130, presence information for the particular user may be passed to the presence server 175 via the cable television/data/telephone network 125. Similarly, presence information determined by the physical location on a wireless device 150, 145 may be passed to the presence server 175 via the wireless telephone/data network 120. Similarly, presence information for a particular user determined by the user's access to a wireline device 140, 135 may be passed to the presence server 175 via the wireline telephone/data network 115. Other devices, for example, the alarm system 155 may pass presence information for a particular user to the presence server 175 via a third party alarm system services provider or via one of the wireline, wireless, or cable-enabled communications networks 115, 120, 125. Alternatively, physical presence information may be detected and transmitted directly from a wireless device 150, 145 to a second device or system for which operational settings or setup data may be changed.

According to an embodiment, a configuration server 176 or application may be utilized for mapping end-point devices comprising operational settings or setup data that may be changed, which presence-detection-enabling devices may be within range of the end-point devices, and which users and features may be mapped to each end-point device and/or location. The configuration server 176 is illustrated in FIG. 1 as an independent component, but as should be appreciated the configuration server 176 may be an application integrated with both client-side devices and/or systems at the facility 110, with server-side devices and/or systems 115, 120, 125, or the configuration server 176 may operate independently of such devices or system where data is pulled from the server 176 by requesting devices/systems or where data is pushed from the server 176 to requesting devices/systems.

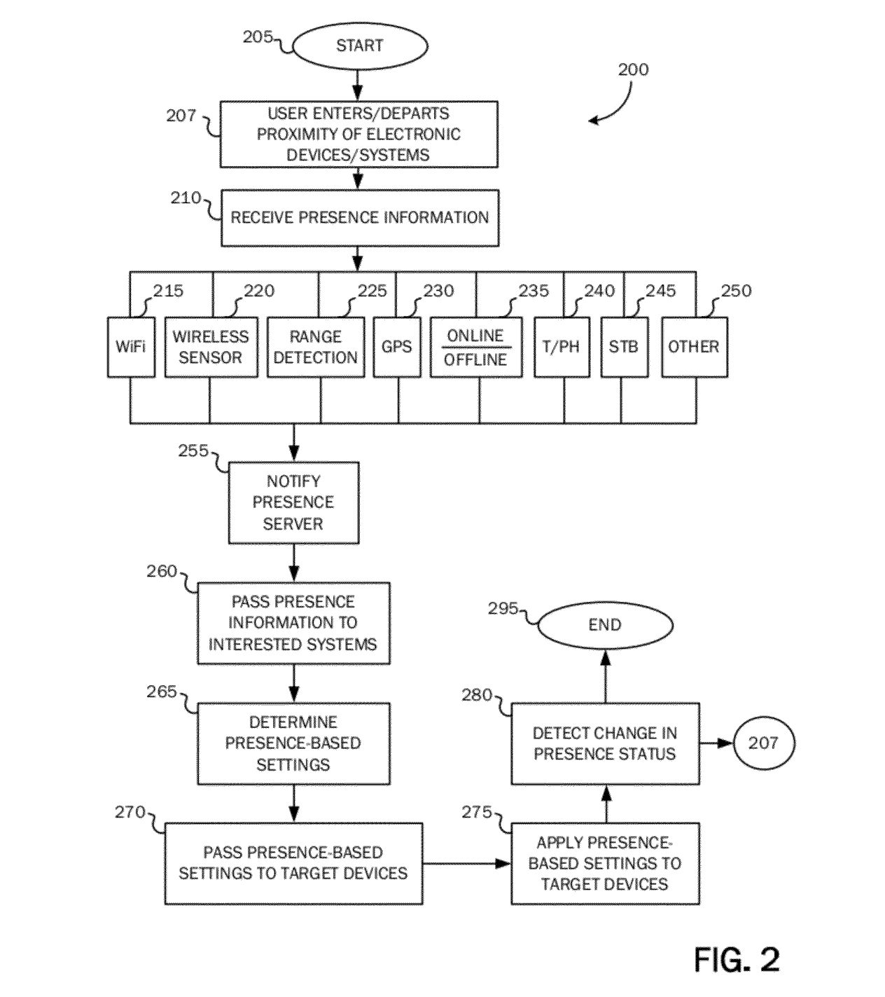

Having described a system architecture with which embodiments of the present invention may be practiced, FIG. 2 is a flow diagram illustrating a routine for automating device/system setup based on presence information. As described above, embodiments of the present invention are directed to automated device/system setup based on user presence information. When a user of one or more electronic devices or systems moves into the presence of the one or more devices or systems, detection or determination of the user's presence may be used to apply setup or settings changes to the one or more devices or systems. For purposes of illustration with respect to the description of FIG. 2 below, consider an example use case in which a user enters a home 110 where the user's presence in proximity of the home is used to make various settings changes to the user's electronic devices contained therein.

The routine 200 begins at start operation 205 and proceeds to operation 207 where a user enters the proximity of one or more electronic devices, for example the electronic devices and/or systems illustrated in the facility (e.g., home) 110. As should be appreciated, operation 207 is equally applicable to detection of the user leaving the proximity of the one or more devices. That is, the receipt of physical presence information of a particular user includes both “in proximity” and “out of proximity” information. In both cases, the operational settings or setup data of one or more electronic devices or systems may be changed. For example, just as settings for a device may be personalized for a user when the user enters the physical presence of the device, so may the settings for the device be changed to another configuration when the user leaves the physical presence of the device. At operation 210, presence information for the user is received via one or more presence detection or presence determination means, as described above with reference to FIG. 1, and as further described below with reference to operations 215 through 250.

At operation 215, if the user is carrying a wireless device 150, 145, for example, a wireless telephone, personal digital assistant (PDA), or wireless computer, the wireless device 150, 145 may detect the presence of a wireless fidelity (WIFI) transmitter/receiver for purposes of connecting with a WIFI with a hotspot for sending and receiving wireless signaling from the wireless device. According to embodiments of the present invention, when the wireless device detects a WIFI signal transmitted via a WIFI transmitter/receiver, physical presence information associated with the wireless device may be passed through the wireless network 120 to the presence server 175 and may be stored for the user. Alternatively, physical presence information associated with the wireless device may be transmitted via an appropriate network to a target device contained in or operated in association with a facility.

At operation 220, the wireless presence detector 165 in the form of a non-WIFI wireless sensor may detect the presence of the wireless devices being carried by the user, and may likewise pass presence information for the user through the wireless network 120 to the presence server 175. As described above, a variety of other wireless presence detection means, for example, BLUETOOTH, infrared (IR), and the like may be equally utilized. In addition, as described above, such information may be passed to the presence server 175, or such information may be passed directly from a user-associated device, such as a carried mobile telephone, to a device or system for which operational settings or setup data may be changed based on the physical presence of the user.

At operation 225, one or more wireless-based positioning technologies (e.g., range detection, triangulation, trilateration, multilateration, observed time difference, time difference of arrival, angle of arrival, etc.) may be employed by the wireless network 120 for determining a location of a wireless device. For example, range detection may be employed by the wireless network 120, wherein a range from the user and his/her wireless devices may be determined based on signal strength from the wireless device to a wireless transmission point 170 (e.g., wireless transmission tower) for determining whether the user and his/her wireless devices are in prescribed physical proximity to the electronic devices contained in the facility 110. Presence information determined for the user via range detection may be passed through the wireless network 120 to the presence server 175.

At operation 230, a satellite-based geo-location receiver (e.g., GPS receiver) operated in the wireless device carried by the user may be utilized for determining global positioning satellite coordinates for the user. Such GPS coordinates may be transmitted through the wireless network 120 to the presence server 175 on a periodic basis. At the presence server 175, the GPS coordinates received for the wireless devices 150, 145 may be compared with GPS coordinates of the facility 110. When the GPS coordinates of the wireless devices 150, 145 carried by the user are within a prescribed proximity to the coordinates of the facility 110, a determination may be made at the presence server 175 that the user and his/her wireless devices are now in the presence of the electronic devices contained in or operated in association with the facility 110.

At operation 235, online/offline status of the user with respect to wireline or wireless data services (e.g., Internet connection) may be utilized to determine that the user is present in the facility 110. As described above with reference to FIG. 1, the online/offline status of the user may be utilized by a data services provider, for example, the wireline telephone network 115, the wireless network 120 or the cable television/data/telephone network 125 for passing presence information to the server 175 for subsequent use.

At operation 240, utilization of a wireline telephone 140 may be utilized for passing presence information for the user from a wireline network 115 to the presence server 175. For example, if the user is identified through a password or other credentials to allow the wireline network 115 to determine that the present user of the wireline telephone 140 is the user for which presence information is of interest, the wireline network 115 may pass presence information for the user to the presence server 175.

At operation 245, utilization by the user of the set-top box 130 may allow a cable television/data/telephone network 125 to determine that the user is present in the facility 110. For example, selection of a particular user profile may allow the cable network 125 to determine that a particular user of interest is physically present in the facility 110, and presence information for the user may be passed to the presence server 175.

At operation 250, use of other electronic devices in the facility 110, for example, use of the alarm system 155, or use of other wireline or wireless devices by a particular user may be utilized for determining that the particular user is present in the facility 110. For example, a particular user may be required to enter a password or other credentials for activating, deactivating or otherwise interacting with an alarm system 155. Such information may be utilized for determining that the particular user is present in the facility 110, and such information may be passed through one or more of the networks 115, 120, 125 or through a third party network, for example, a third party alarm system, to the presence server 175.

According to embodiments, use of an electronic device in the facility for indicating user presence may include notifying a network component (e.g., a wireless, wireline or cable services network component) of the use of the electronic device or of the use of another electronic device associated with the electronic device. That is, notification of the use of the one or more devices is passed to a network component operative to interpret the use of the electronic device or the use of another electronic device as an indication that the user is in a physical proximity of the electronic device. For example, a user's setting of channels on a set-top box may cause a notification to a cable services system that the user is in the presence of the set-top box.

At operation 255, presence information for a particular user detected or determined through one of the above-described means may be passed to the presence server for subsequent use. According to one embodiment, a database object may be maintained at the presence server 175, the configuration server 176, or other suitable storage location that may represent a list of “interested devices or systems” that will receive physical presence information for a given user as the presence information changes. At operation 260, presence information for a particular user may be passed to interested systems. For example, the presence information for one or more particular users located in the facility 110 may be passed to the wireline telephone network 115, the wireless network 120, the cable television/data/telephone network 125, or other interested systems, for example, a remote alarm system associated with the in-facility alarm system 155, or any other interested system responsible for managing or providing services to one or more electronic devices or systems in the facility 110. As should be appreciated, an interested system may be in a fixed geographical location, or may be in a variable geographic location. For example, physical presence information for a particular user may be passed to a car, wherein various settings may be applied depending on the presence of the particular user.

According to embodiments, presence information passed from the presence server 175 to interested systems may be passed to the systems on a push or pull basis. That is, on a periodic frequency, for example, once every ten seconds or once every five minutes, presence information may be pushed from the presence server out to each interested system that is registered with the presence server for receiving presence information for one or more particular users. Conversely, presence information may be pushed to an interested system upon detection of a change of presence information. For example, upon a user's arrival at home, an “at home” presence status may be pushed to his/her home devices. Subsequent presence information may not be pushed to his/her home devices until the next morning, when the user leaves his/her home. Alternatively, presence information may be pulled from the presence server 175 by interested systems on a frequency established for each individual system. For example, the cable network 125 may pull presence information from the presence server for its customers/subscribers once every five minutes. On the other hand, a wireless network 120 may pull presence information from the presence server 175 for its customers/subscribers once every ten seconds. As should be appreciated, each individual interested system may need presence information for particular users on different frequencies depending on the services provided by the individual communications systems.

At operation 265, a determination is made as to presence-based settings applicable to one or more electronic devices operating in the facility 110. For example, if a particular user is detected as being present within the facility 110, a prescribed set of viewing channels may automatically be populated at the set-top box 130 via the cable television/data/telephone network 125. That is, if a particular user only enjoys viewing channels 1, 4, 8, and 15 available through his cable services provider, then upon a detection or determination of his presence in the facility 110, the cable services provider through the network 125 and based upon presence information received from the presence server 175 may cause the set-top box 130 associated with the user's television set to provide only those viewing channels desired by the particular user. As should be appreciated, if a second user enters the facility 110 having a different desired set of viewing channels, presence information for the second user may be utilized for causing a second set of viewing channels to be provided via the set-top box 130 in addition to the set of viewing channels desired by the first user entering the presence of the facility 110.

For another example, Internet services provided to one or more wireless or wireline computing devices 150, 145, 135 via one or more of the networks 115, 120, 125 may be limited based on the presence of a particular user in the facility 110. For example, a parent or supervisor may require that children in the facility 110 may only access Internet services when the parent or supervisor is physically present in the facility 110. Thus, the Internet capability of systems or devices contained in the facility 110 may be automatically placed in a setting preventing Internet access or limiting Internet access to prescribed Internet sites until the parent or supervisor is present in the facility 110. When presence information for the parent or supervisor indicates that the parent or supervisor is present in the facility 110, the communications services providers for the Internet services utilized in the facility 110 may automatically change the settings for the Internet capable devices to allow broader Internet access by other users in the facility 110.

For another example, an alarm system 155 may be set to automatically activate if the presence of a particular user is no longer determined or detected in the facility 110. If a particular user leaves the facility 110, the alarm system 155 may be set to automatically activate based on a change in the presence information for the particular user.

For another example, if a user of the wireless telephone 150 is determined or detected as being present in the facility 110, the wireless network 120 responsible for providing wireless telephony services to the wireless telephone 150 may automatically forward calls directed to the wireless telephone 150 to a wireline telephone 140 based on the presence of the user of the wireless telephone 150 in the facility 110.

At operation 270, presence-based settings are passed from the appropriate networks 115, 120, 125 to the target devices contained in or operated in association with the facility 110. According to embodiments, user preferences may be stored at the backend systems of the networks 115, 120, 125, or may be stored at the client side at the one or more electronic devices in the facility 110. For example, user preferences as to preferred channels for television viewing may be stored at a cable services system backend or at the set-top box 130. For another example, call forwarding preferences implemented based on the user's presence at the facility 110 may be stored at a wireless or wireline network backend or via client side applications/memory at local wireline and wireless telephones. As should be appreciated, functionality for passing presence-based settings to the target devices may be maintained and operated in the networks 115, 120, 125, or functionality for processing presence-based settings changes to the target devices may be operated by client-side applications operated at the target devices at the facility 110 based on presence information passed to the target devices from the presence server via one or more of the networks 115, 120, 125.

At operation 275, presence-based settings are applied to the one or more target devices either from a backend application at one or more of the networks 115, 120, 125 or via client-side applications operated on each of the one or more target devices based on presence information passed to the target devices. According to embodiments, presence-based settings are applied to personalize the settings or set up of the one or more electronic devices based on the user's presence in a proximity of the one or more electronic devices. That is, one or more functionalities of the electronic device(s) may be personalized for the user based on one or more preferences of the user.

As should be appreciated, changes made to the operational settings or setup data for one or more target devices may be performed based on the physical presence of multiple users. For example, in a given household, two or more members of a family may be in the physical presence of the one or more target devices, and device settings associated with each of the members/users may be applied. According to one embodiment, all settings associated with all physically present users may be applied simultaneously. For example, if a first physically present user prefers channels 1-10 via her cable television set-top box, and a second physically present user prefers channels 11-20, the physical presence of both users may cause all of channels 1-20 to be enabled via the set-top box. For another example, if the physical presence of a child causes certain Internet access to be limited, but an adult with broader Internet access settings is also physically present, then the broader settings may be applied such that the settings of the parent (first user) take precedence over the settings of the child (second user). As should be appreciated, the various settings for various users and any hierarchical relationships between settings (e.g., parent versus child) may be stored as user profile data for the various users and may be accessed by a given device for application based on the physical presence of different users. Such data may be stored in the configuration server 176 or similar remote storage site, or such data may be stored on the client-side of any given interested target device or system.

At operation 280, any changes in presence information for one or more users present in or near the facility 110 are detected or determined. For example, if a particular user is presently in the facility 110, but leaves the facility 110, a determination that the particular user is no longer present in the 110 may be passed to the present server 175, and any settings changes applicable to the devices operated in the facility 110 may be made in accordance with the change in presence status for the particular user. If any changes in presence information for one or more users present in or near the facility 110 are detected or determined, the routine then may proceed back to operation 207 where physical presence information for one or more users may be detected and utilized as described herein. If no changes in presence information are detected or determined, the routine may end at operation 295.

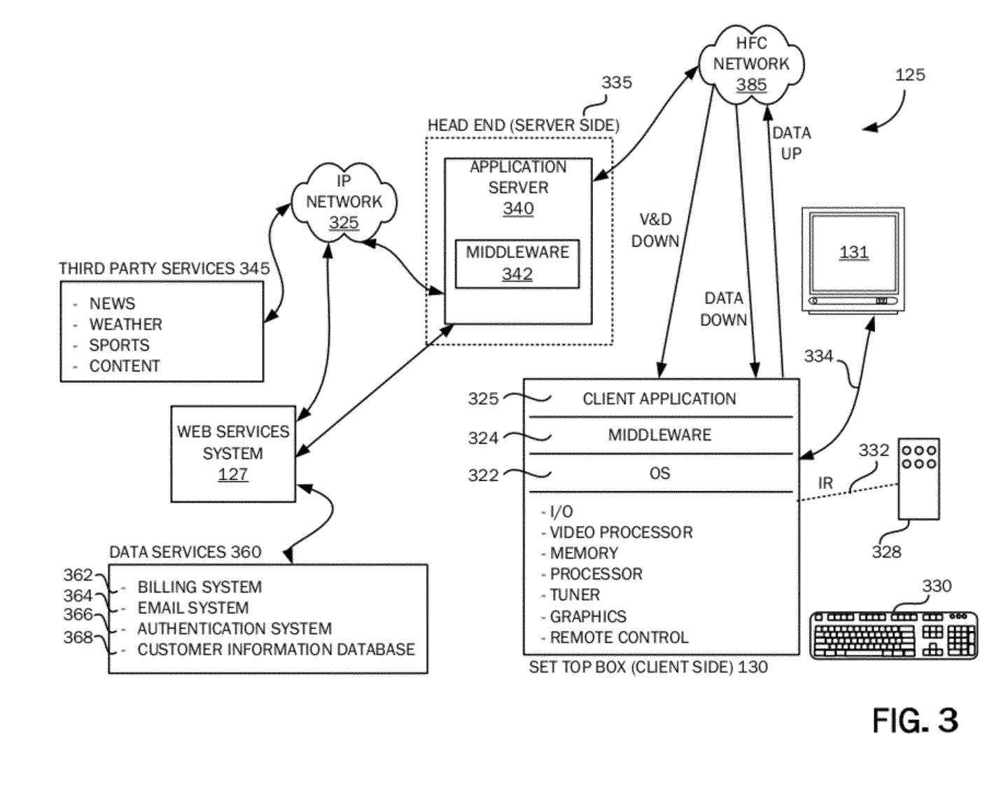

As described above with reference to FIGS. 2 and 3, one network with which embodiments of the invention may be practiced includes a cable television/data/telephone network 125. FIG. 3 is a simplified block diagram illustrating a cable services system (hereafter referred to as “CATV”) architecture that may serves as an exemplary operating environment for embodiments of the present invention.

Referring now to FIG. 3, digital and analog video programming, information content and interactive television services are provided via a hybrid fiber coax (HFC) network 150 to a television set 160 for consumption by a cable television/services system customer. The functionality of the HFC network 150 allows for efficient bidirectional data flow between the client-side set-top box 155 and the server-side application server 340 of the present invention. Embodiments of the present invention are not limited to an HFC network 150, but may include other transport mediums included, but not limited to, an all fiber system, an all coax system, and an IP Ethernet-based system. According to embodiments of the present invention, the CATV system 300 is in the form of a distributed client-server computing system for providing video and data flow across the HFC network 150 between server-side services providers (e.g., cable television/services providers) via a server-side head end 145 and a client-side customer via a client-side set-top box (STB) functionally connected to a customer receiving device, such as the television set 160.

On the client side of the CATV system 300, digital and analog video programming and digital and analog data are provided to the customer television set 160 via the set-top box (STB) 130. Interactive television services that allow a customer to input data to the CATV system 300 likewise are provided by the STB 130. As illustrated in FIG. 3, the STB 130 is a multipurpose computing device having a computer processor, memory and an input/output mechanism. The input/output mechanism receives input from server-side processes via the HFC network 150 and from customers via input devices such as the remote control device 175 and the keyboard 330.

Because a variety of different operating systems 322 may be utilized by a variety of different brands and types of set-top boxes, a middleware layer 324 is provided to allow a given software application to be executed by a variety of different operating systems. According to an embodiment of the present invention, the middleware layer 324 may include a set of application programming interfaces (API) that are exposed to client applications 325 and operating systems 322 that allow the client applications to communicate with the operating systems through common data calls understood via the API set. Referring still to FIG. 3, the head end 145 of the CATV system 300 is positioned on the server side of the CATV system and includes hardware and software systems responsible for originating and managing content for distributing through the HFC network 150 to client-side STBs 130 for presentation to customers via televisions 160. As described above, a number of services may be provided by the CATV system 300, including digital and analog video programming, interactive television services, telephone services, video-on-demand services, targeted advertising, and provision of information content.

The application server 340 is a general-purpose computing system operative to assemble and manage data sent to and received from the client-side set-top box 130 via the HFC network 150. As described above with reference to the set-top box 130, the application server 340 includes a middleware layer 342 for processing and preparing data from the head end of the CATV system 300 for receipt and use by the client-side set-top box 130. For example, the application server 340 via the middleware layer 342 may obtain data from third-party services 346 via the Internet 120 for transmitting to a customer through the HFC network 150 and the set-top box 130. For example, a weather report from a third-party weather service may be downloaded by the application server via the Internet 120. When the application server 340 receives the downloaded weather report, the middleware layer 342 may be utilized to format the weather report for receipt and use by the set-top box 130. According to one embodiment of the present invention, data obtained and managed by the middleware layer 342 of the application server 340 is formatted according to the Extensible Markup Language and is passed to the set-top box 130 through the HFC network 150 where the XML-formatted data may be utilized by a client application 325 in concert with the middleware layer 324, as described above. As should be appreciated by those skilled in the art, a variety of third-party services data, including news data, weather data, sports data and other information content may be obtained by the application server 340 via distributed computing environments such as the Internet 120 for provision to customers via the HFC network 150 and the set-top box 130.

According to embodiments of the present invention, the application server 340 obtains customer profile data from services provider data services 360 for preparing a customer profile that may be utilized by the set-top box 130 for tailoring certain content provided to the customer. According to an embodiment of the present invention, a customer profile may include communications applications provisioned on networked STBs, as well as, designations of individual STBs in a home, business or facility (e.g., “kitchen STB,” “bedroom STB,” “office STB,” and the like).

As illustrated in FIG. 3, the services provider data services 360 include a number of services operated by the services provider of the CATV system 300 which may include data on a given customer. For example, a billing system 362 may include information such as a customer's name, street address, business identification number, Social Security number, credit history, and information regarding services and products subscribed to by the customer. An electronic mail system 364 may contain information such as electronic mail addresses, high-speed Internet access subscription information and electronic mail usage data. An authentication system 366 may include information such as secure user names and passwords utilized by customers for access to network services. The customer information database 368 may include general information about customers such as place of employment, business address, business telephone number and demographic information such as age, gender, educational level, and the like. As should be understood by those skilled in the art, the disparate data services systems 362, 364, 366, 368 are illustrated as a collection of data services for purposes of example only. The example data services systems comprising the data services 360 may operate as separate data services systems, which communicate with a web services system (described below) along a number of different communication paths and according to a number of different communication protocols.

Although described herein with respect to setup changes to various electronic devices via server side and or client side applications, in alternative embodiments, the invention may be used in combination with any number of computer systems, such as in desktop environments, laptop or notebook computer systems, multiprocessor systems, micro-processor based or programmable consumer electronics, network PCs, mini computers, main frame computers and the like. Embodiments of the present invention may be utilized in various distributed computing environments where tasks are performed by remote processing devices that are linked through a communications network in a distributed computing environment.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention. Although embodiments of the present invention have been described with reference to particular standards and protocols, the present invention is not limited to such standards and protocols.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method of automating setup changes to an electronic device based on user presence information, comprising:
receiving presence information for a specific user of an electronic device, the presence information indicating the user is in a physical proximity of the electronic device;
passing the presence information for the user of the electronic device to the electronic device to indicate the user is in a physical proximity of the electronic device; and
in response to receiving the presence information for the user of the electronic device at the electronic device, changing one or more settings of the electronic device based on the indication that the user is in a physical proximity of the electronic device.

2. The method of claim 1, wherein changing one or more settings of the electronic device based on the indication that the user is in a physical proximity of the electronic device includes personalizing one or more functionalities of the electronic device based on one or more preferences of the user.

3. The method of claim 2, wherein personalizing one or more functionalities of the electronic device includes personalizing one or more functionalities of the electronic device based on user preferences profile information maintained for the user in association with the electronic device.

4. The method of claim 1, wherein receiving presence information for the user of the electronic device includes receiving signaling from a wireless communications device physically associated with the user at a wireless presence detector located in a physical proximity of the electronic device.

5. The method of claim 4, wherein passing the presence information for the user of the electronic device to the electronic device to indicate the user is in a physical proximity of the electronic device includes passing the presence information to the electronic device via the wireless presence detector.

6. The method of claim 1, wherein receiving presence information for the user of the electronic device includes detection of a wireless presence detector by a second electronic device in a possession of the user; and wherein passing the presence information for the user of the electronic device to the electronic device to indicate the user is in a physical proximity of the electronic device includes passing the presence information directly from the second electronic device to the electronic device for which one or more settings are changed based on the indication that the user is in a physical proximity of the electronic device.

7. The method of claim 1, wherein receiving presence information for the user of the electronic device includes detecting a location of the user relative to the electronic device based on a distance from a wireless communications device physically associated with the user to a wireless network transmission point.

8. The method of claim 7, wherein if the location of the user relative to the electronic device based on a distance from the wireless communications device physically associated with the user to the wireless network transmission point indicates that the user is within a prescribed proximity of the electronic device, indicating the user is in a physical proximity of the electronic device.

9. The method of claim 1, wherein receiving presence information for the user of the electronic device includes determining a location of the user relative to the electronic device based on global positioning satellite data for a wireless communications device physically associated with the user.

10. The method of claim 9, wherein if the location of the user relative to the electronic device based on global positioning satellite data for a wireless communications device indicates that the user is within a prescribed proximity of the electronic device, indicating the user is in a physical proximity of the electronic device.

11. The method of claim 1, wherein receiving presence information for the user of the electronic device includes receiving an indication the user is in a physical proximity of the electronic device based on use of the electronic device or use of another electronic device in the physical proximity of the electronic device, wherein use of the electronic device or use of another electronic device indicates the user is in the physical proximity of the electronic device.

12. The method of claim 11, wherein a notification of the use of the electronic device or of the use of another electronic device is passed to a network component operative to interpret the use of the electronic device or the use of the another electronic device as an indication that the user is in a physical proximity of the electronic device.

13. The method of claim 1, wherein receiving presence information for the user of the electronic device includes receiving the presence information for the user of the electronic device at a presence server operative to notify a communications system through which the electronic device operates that the user is in the physical proximity of the electronic device.

14. The method of claim 1, wherein passing the presence information for the user of the electronic device to the electronic device to indicate the user is in a physical proximity of the electronic device includes passing the presence information for the user of the electronic device to the electronic device via a communications system operative to change one or more settings of the electronic device based on the user's physical proximity with the electronic device.

15. A method of automating setup changes to an electronic device based on user presence information, comprising:
receiving presence information for one or more users of an electronic device, the presence information indicating the one or more users are in a physical presence of the electronic device;
passing the presence information for the one or more users of the electronic device to the electronic device to indicate the one or more users are in a physical presence of the electronic device; and
in response to receiving the presence information for the one or more users of the electronic device at the electronic device, changing one or more settings of the electronic device based on the indication that the one or more users are in a physical presence of the electronic device, including personalizing one or more functionalities of the electronic device based on user preferences profile information maintained for the one or more users in association with the electronic device.

16. The method of claim 15, wherein changing one or more settings of the electronic device based on the indication that the one or more users are in a physical presence of the electronic device includes applying one or more settings associated with each of the one or more users to the electronic device simultaneously.

17. The method of claim 15,
further comprising determining whether one or more settings of a first user takes precedence over the one or more settings of a second user; and
wherein changing one or more settings of the electronic device based on the indication that the one or more users are in a physical presence of the electronic device includes applying one or more settings associated with the first user and the second user such that the one or more settings associated with the first user take precedence over application of the one or more settings associated with the second user.

18. The method of claim 15, wherein receiving presence information for the one or more users of the electronic device includes receiving an indication the one or more users are in a physical presence of the electronic device based on use of the electronic device or use of another electronic device in the physical presence of the electronic device, wherein use of the electronic device or use of another electronic device indicates the one or more users are in the physical presence of the electronic device.

19. A method of automating setup changes to an electronic device based on user presence information, comprising:
receiving an indication a user is in a physical proximity of an electronic device based on use of the electronic device or use of another electronic device in the physical proximity of the electronic device;
passing the presence information for the user of the electronic device to the electronic device to indicate the user is in a physical proximity of the electronic device; and
in response to receiving the presence information for the user of the electronic device at the electronic device, changing one or more settings of the electronic device based on the indication that the user is in a physical proximity of the electronic device.

20. The method of claim 19, wherein a notification of the use of the electronic device or of the use of another electronic device is passed to a network component operative to interpret the use of the electronic device or the use of the another electronic device as an indication that the user is in a physical proximity of the electronic device.
